(19) United States
(12) Patent Application Publication
(10) Pub. No.: US 2005/0174725 A1
(43) Pub. Date: Aug. 11, 2005

(54) Network station for cybercafe (NSCC)

(76) Inventor: Javier Bernardo Zales Hodara, Montevideo (UY)

Correspondence Address: COLLEN IP, THE HOLYOKE MANHATTAN BUILDING, 80 SOUTH HIGHLAND AVENUE, OSSINING, NY, 10562, US

(21) Appl. No.: 10/937,202

(22) Filed: Sep. 9, 2004

(30) Foreign Application Priority Data
Sep. 9, 2003 (UY) 3973

(51) Int. Cl. G06F 1/16

(52) U.S. Cl. 361/681; 361/142

(57) ABSTRACT

Network Station for Cybercafe which operates both as a device for dinning and as a network station, both functions occur in the same place and time, hardly interfering between them. The design includes a horizontal board, on the upper surface of which food and drinks and related elements are set, and below the board is located the screen, the controlling elements (keyboard and mouse pointers), the CPU and the concealed connections. By this model more than one user may have access jointly to the network simultaneously and in the same terminal.

### BACKGROUND OF THE UTILITY MODEL

“The world is now witnessing a new industrial revolution. By now, the network of networks is not only a context for exchanging information. It shapes our world into a new dimension. The Internet is becoming every day more and more part of our lives. And then, more and more, our lives depend on the Internet.

More frequently, people need or wish to have access to the information provided by the Internet when they are not at home or in their office. For this reason, Internet terminals for public use have been created and they are now found in the following contexts: libraries, teaching centers, conference rooms, cyber cafes, transport terminals (ports, airports), public highways and commercial shops such as supermarkets, malls or others.

It is much likely that the Internet is far from being a tool that carries people away into a world of their own, as may have been thought at the beginning. On the contrary, the Internet has become a communication tool between its users. Through the Internet, people may know, exchange and share other person's feelings and viewpoints throughout the world. This fact has made of the Internet a new area of socialization and recreation, and as such its use has become a longstanding habit. This new phenomena is the reason for our creation of the object NSCC.

At the same time, and upon analysis of the recreational contexts that are available nowadays in our society, the following conclusions may be reached: recreational activities need to be renewed to promote the development of relationships between individuals and their socialization. Furthermore, there is not yet a context in which technology is employed with a socializing purpose.

Our model herein introduced has been designed taking into consideration the above-mentioned reasons. In order to achieve the model of NSCC that has been thoroughly described, the contexts in which there is access to the Internet and the kind of terminals used had to be previously studied. Therefore, our utility model is created based on the analysis of the station used by the user to access to the information provided by the Internet and on the context in which said access takes place. The Cyber Café is the particular context in which the description is focused.

Usually, the models found are designed for only one user. Most of the manufacturers of this kind of terminals do not consider specially the context in which the terminal shall be used. Most commonly, they pick up the model based on the disposition of the user: standing or sitting. Terminals should be designed taking into consideration the scope of the use thereof, since this determines the use that said stations shall have, which in turn determines the model thereof.

Generally, the models that are available in the market, particularly in Cyber Cafes, are writing desk terminals, set on regular computer desks with their corresponding computer chair as usually found in offices. Under these conditions when the terminal is used there is not a free surface, properly separated from the different computer components, for resting food, beverages and all the elements related thereto. Therefore, this model cannot be applied to the use of the desk for lunch or dinner, for coffee, tea or sodas or for team work with more than one user in the same terminal.

The object of the present invention solves the above-mentioned limitations in that it is an NSCC specially designed both for the above-mentioned functions and to be used simultaneously by more than one user, and at the same time the users may comfortably consume food or carry out other activities in the station.

The NSCC model hereby introduced has been designed to be used in facilities where people use both the connection to the Internet while they have something to eat, and therefore, the model may be used simultaneously by more than one individual and the desk may have the regular use given to tables for lunch, dinner, coffee, tea, etc.

### SUMMARY OF THE UTILITY MODEL

The object of the present invention is an NSCC which includes in a single product a surface for having lunch, dinner, tea, soda or for work, and at the same time a terminal to have access to a computers network and Internet, in such a way that more than one user may carry out both activities at the same time in one single station.

Even more, another object of the present invention is an NSCC in which work, recreation and enjoying food and drinks occur simultaneously. This scenario encourages the development of relationships between people that use the Internet, and thus the tool becomes more socializing and less individualistic.

The NSCC model introduced herein may be used specifically both as dinning table and/or as an Internet access terminal by more than one user simultaneously.

The NSCC model introduced herein has been modified for operational purposes, mainly in the double function of dinning table and Internet access terminal. Furthermore, the object has been designed in such a way, that the user thereof may work with or connect to the Internet as member of a group, as well as enjoy lunch or dinner with other users who may all together have access to the network of networks, and event which is usually carried out individually.

The components of the NSCC are well-defined: a wide surface to rest the corresponding elements and enjoy lunch, dinner, tea, coffee, etc., without interfering in the use of the terminal. The terminal screen in such a position that it becomes visible to all the members of the group at the same time and, furthermore, that may be positioned in the direction of any of the members of the group. The controlling elements of the terminal, keyboard and mouse pointer, The central processing unit of the terminal (CPU). The connections between the CPU, screen, controlling elements, network and electric energy are underneath the table and between its legs and are concealed or not visible. Even some of the above-mentioned are wireless connections.

### DESCRIPTION OF THE DRAWINGS

FIG. 1 shows a Perspective view of the product and the description of the parts of the product.

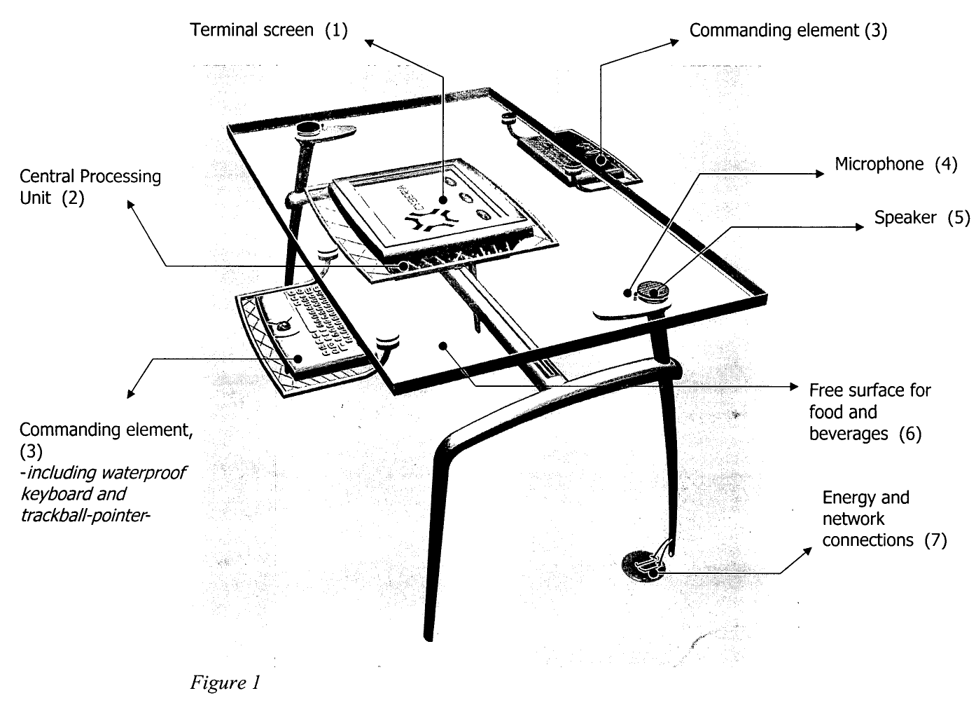

FIG. 2 shows an Overview of the product

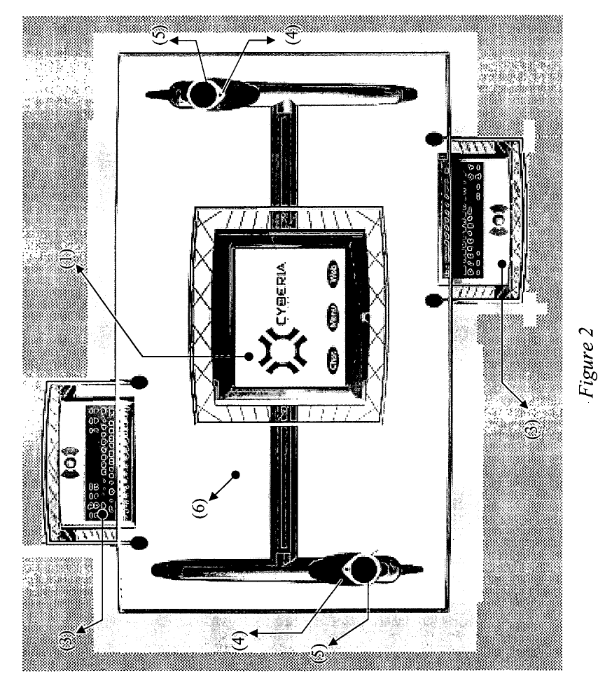

FIG. 3 shows a Front view of the product.

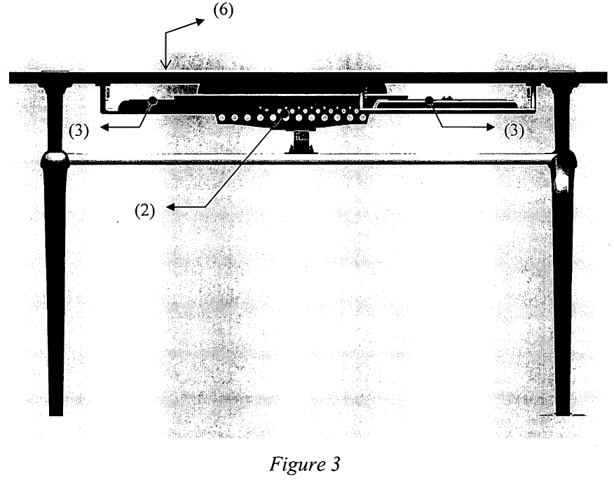

FIG. 4 shows a Right Side view of the product.

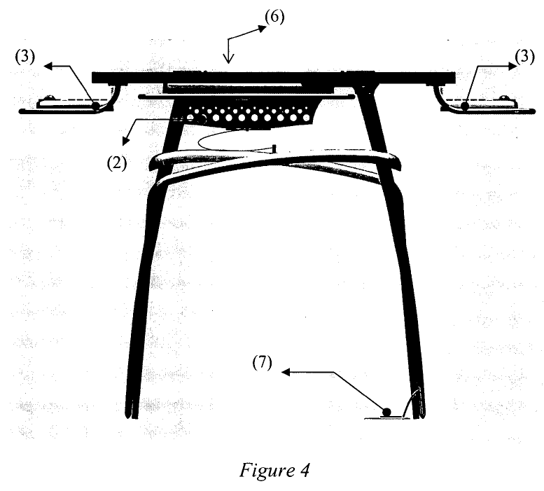

### DESCRIPTION OF THE NSCC

The NSCC introduced herein has specific characteristics related to the fact that it can be used both as dinning table and as an Internet access terminal.

The NSCC created by us may be used both for dinning and as a terminal. These two uses may be made in the same place and at the same time without interference. With this purpose, a physical division has been defined between both uses which separates the elements used in each of both functions. This physical division is an imaginary horizontal plane which is the upper surface of the table board. Over said surface is the free surface used for resting all elements related to food and beverages (6). Underneath are all the elements related to the network terminal: the screen (1), the CPU (2), commands, connections, and the speakers (5). The NSCC is designed to encourage the participation in group activities of every one sitting at the table. This model integrates all members to the group.

The NSCC is an independent product that includes all necessary technological elements, may be moved from one place to another and may be set in any kind of room, that is, all the elements that are part of NSCC are included therein. Thus, for operation, the NSCC requires only a connection to the energy source and to the network (7). The NSCC includes a flat surface (6) for resting food and drinks and related elements just as the surfaces used for traditional dinning tables. Furthermore, it includes a network terminal composed by a screen (1) connected to a central processing unit (CPU)(2) and to the corresponding commands (keyboard and mouse pointer). The screen (1) is held by a magnetic system by which it may be directed to each one of the users. The CPU (2) is next to the screen (1) in the same cabinet. The commands are kept underneath the table board, in such a way that every user of the utility model may have easy access thereto whenever they wish to do so, by simply drawing them from underneath the table board.

The shape of the NSCC has been designed in such a way that the elements of the network terminal and the food are always physically separated. The surface (6) used for resting food mentioned above is a translucid crystal glass horizontal board through which the screen (1) is always visible. Underneath this crystal glass board users may have access to the screen (1), placing it in the more suitable position as may be required. Also underneath the table board are the commands (keyboard and mouse pointer) and the speakers (5), in such a way that they do not interfere with nor share the areas used for resting foods or related elements. The keyboard and mouse pointer are located underneath the board surface as part of a unique controlling element (3). By means of a holding magnetic system similar to the system used for the screen (1), the controlling element (3) may be drawn sideward from the board as a retractable tray. The NSCC model herein introduced includes two of these controlling elements (3) through which all the users may have easy access to at least one of the controlling elements (3) wherever they are sitting around the table.

Underneath are also the terminal, electric energy and network connections. Said connections are kept inside of the table base and run out through one of the stations legs by the floor to connect with an energy and network outlet which is presumably on the floor near the station (7).

At the same time the terminal which is an integral part of NSCC operates with a software for its specific functions such as: communication between different stations, by writing (chat), spoken conversations or web-conference calls, access to the information provided by the Internet, access to and ordering of the food and drinks menu.

The glass board of the NSCC is made of a hermetic double glass blazing with two glass sheets (one 0.6 cm wide and the other 1.2 cm wide) the edges of which are joined by an aluminum frame with silicagel grains in the inside. The outer surface of this frame bears a structural silicone layer that seals the double glass blazing. The sealing avoids condensation in the inside of the double glass blazing, which prevents the glass from blurring by temperature variations when hot dishes are set on the table which in turn would make the screen (1) non-visible. Even more, this board includes a metallic edge around all its perimeter made of an L-shaped section steel profile, which covers the glass sheet joints and that blocks the absorption system of the controlling element (3).

The electric energy and network connection (7) is made through one of the conic legs of the table. The wires come out through two openings near the floor. Said openings are indicated by a round stripe colored differently than the rest of the leg, the color matching the chair slings and the terminal elements. By this the leg that includes the connections (7) is identified and becomes evident. The network and energy wires with plugs (RJ45 and Schuko, respectively) are controlled by a retractile system to keep them rolled up inside the leg when disconnected and the plugs remain by the openings. Thus the table may be swiftly moved, without the inconvenience of dangling elements. The speakers (5) are embedded in the glass board over the cast iron pieces supporting said board. Said speakers (5) are in an upward position. Each one of these speakers (5) is next to a microphone for general reception (4), also embedded in the glass board. (Optional:) Underneath the glass board over the legs, on each side of the table there are two complementary hearing aids that include a microphone. Said hearing aids are engaged to a base and connected to the NSCC by a retractile wire. They may be used by the terminal users during spoken conversation on line, to prevent the general noise of the room from interfering with the conversation. Likewise, when using the hearing aids the terminal speakers (5) shall not turn off to avoid any one of the users to be excluded from the rest of the group at the table.

Because of the characteristics of the proposed context, the tables shall be located in predetermined positions, but they may be moved. Therefore, these tables may be rotated and moved together into larger working desks, if a special situation requires to do so.

For this purpose, the applicable positions of the tables were examined, which determined the locations of the outlet boxes on the floor. Considering the fact that one outlet box is required for each table, and trying to set tables together with as few movements as possible, the usual disposition was attained. Therefore, each table has one outlet box between tables depending on the dimension of the larger side. Out of the above-mentioned, the number and position of the tables in the designed areas may vary.

Regarding the terminal included in the table, the subproducts, monitor/CPU (1&2) and commanding element (3) and its features are introduced separately herein below.

The commanding element (3) includes an already known waterproof keyboard, with metal keys, especially designed for public terminals and a TrackBall with its corresponding buttons.

The commanding elements (3) and the central processing unit (2) are connected through a wireless system of communication. This communication applies radio frequency technology and the broadcasting frequency varies to avoid interference between the keyboards of the different terminals. The radio frequency broadcaster is placed inside of the casing. This element includes a handrail for the users to place the element in the position that suits them better. The handrail and the casing of the element are joined by PVC-lined slings. The lining of the slings are of the same color as the TrackBall ball and also as the color of the weaved slings of the chair and the back of the chairs of the same terminal. These elements come in three colors (orange, green and purple), depending on their location in the room. The commanding element (3) is suspended underneath the glass board of the table. Said element remains attached to the glass board by a magnetic system that includes magnets on the handrail ends and magnetic cartridges placed inside the hermetic double glass blazing. The magnetic strength of both magnets keeps the commanding element (3) attached to the lower face of the glass. The portions of the model that slide against the glass include a teflon sheet of a special texture that minimizes the frictional forces and facilitates sliding. Said element may be inclined from the table by an absorption mechanism. This mechanism also prevents the keyboard from disengaging from the glass when the user applies strength on the handrail to move the keyboard. Because of the L-shaped metal profile around the perimeter of the table, the absorption mechanism is interrupted when the controlling element (3) is attached to the edge of the table. The monitor/CPU (1&2) element is composed of a 17″ or 15″ screen (1) depending on the size of the terminal, a webcam and a central processing unit (CPU)(2).

This element is suspended underneath the table board, and held by a magnetic system, that includes magnets on a frame around the screen (1) on the upper portion of the casing and magnets in the other frame of same size and shape inside the hermetic double glass blazing. The device remains attached to the lower face of the glass because of the strength between both frames. The element may be located in any place in the table and in any position by the above-described mechanism. This monitor/CPU (1&2) is surrounded by a handrail for the user to move and locate the monitor/CPU (1&2) in the position in which he/she may have a good sight of the screen (1). Said handrail is attached to the casing by PVC-lined slings, that come in three colors (orange, green and purple), depending on the location of the element in the room. The monitor/CPU (1&2) may be moved by two users jointly, positioned on each side of the table. The location of the monitor/CPU (1&2) also determines the picture to be taken by the webcam. The camera's angle may be varied by a flap found underneath the casing that turns round the camera. Considering the particularities of the room, the light of the screen (1) also illuminates the table locally, in the same way as a traditional table of a restaurant or bar is illuminated by a candle.

The monitor/CPU (1&2) is connected to the rest of the product by a 28-line flat wire. These conduct electric energy, network information and ingoing and outgoing sound. The wire is connected to the bottom of the monitor through a rotation system based on a roller bearing. By this system the monitor may be rotated while the wire remains in the same direction. The other end of the wire is connected to the table structure by a connector running on a rail on the transverse tube. By this mechanism the wire may be moved along the table, thus the monitor/CPU (1&2) may be easily located in any part thereof. The following two precautionary measures have been taken to prevent disengagement of the monitor/CPU (1&2) from the glass and dropping thereof to the floor, if the user applies downward strength on the handrail:
1) As mentioned before, the handrail and casing are joined by rather flexible slings. Thus, the handrail may be inclined with respect to the casing.
2) The slings and the handrail are joined by a frame pressed on the joint. If the downward strength applied on the handrail exceeds a certain limited value, the handrail disengages from the frame and remains held by the user, but the monitor/CPU (1&2) does not disengage from the glass board and is not dropped to the floor.

The terminal shall be used for four main purposes. Therefore, it shall include a specific software to comply with said purposes. The following are the purposes of the terminal:
1) Communication between users, either within the facilities or in any other branch of the cyber cafes chain. For this purpose, written messages (Chat) may be sent and received from the terminal and users may hold a spoken conversation by microphones (4) or establish a web-conference call using a webcam in the terminal.
2) Users may pick up a dish and drinks from the menu and place their orders. For this purpose, there shall be access to all the information regarding ingredients of each dish, including pictures, and specific answers may be made to a virtual waiter.
3) The user may use a large screen from the facility or from any other branch to publish anything the user may wish, such as an video clip chosen on line or a message picked up by the terminal's webcam.
4) The users may browse through Internet sites they may wish.

The object of the present application has been described herein. It is evident that said application complies with all the requirements established by the laws in force related to the matter, and that none of the prohibitions established therein are applicable. Thus, the protection of the utility model, described in the following claims, is sought.

1) Network Station for Cybercafe (NSCC), which integrates in a single object, both a common table and a network terminal with access to the Internet.

2) Network Station for Cybercafe (NSCC), as claimed in 1, which may be used simultaneously by more than one user.

3) Network Station for Cybercafe (NSCC), as claimed in 1, which includes a horizontal board, with an imaginary plane of division on its upper surface to set the food and drinks and related elements, underneath of which are the terminal components such as the screen, commands (keyboards and mouse pointers), speakers, CPU and connections.

4) Network Station for Cybercafe (NSCC), as claimed in 1, which includes a horizontal board of translucid double crystal glass through which the screen and the commands located underneath may be clearly seen, and by which the screen, the commanding elements and the elements related to the magnetic supporting system may be slid.

5. Network Station for Cyber Cafes (NSCC), as claimed in claim 1, composed by the subproduct screen/CPU that may be slid underneath the board (double crystal glass) by a magnetic system composed of a framework with magnets in the casing itself and another frame with magnets in the inner surface of the double glass which holds the device.

6. Network Station for Cyber Cafes (NSCC), as claimed in claim 1, which includes an absorption mechanism by which the commanding element, held by the same magnetic system, may be inclined with respect to the table. Thus, the keyboard does not disengage from the glass when the user applies strength on the handrail to move the keyboard, the system is interrupted when the commanding element is attached to the edge of the table by the L-shaped metallic profile around the table.

7. Network Station for Cyber Cafes (NSCC) as claimed in claim 1, which includes concealed connections which are not visible and that run through the inner surface of the structure, some of which are wireless and come out through one of the table's legs to couple with an outlet located on the floor.

8. Network Station for Cyber Cafes (NSCC), as claimed in claim 1, which includes a software for communication between different stations and access to the Internet and to order food and drinks included in a virtual menu.
